(19) United States
(12) Patent Application Publication
(10) Pub. No.: US 2024/0387912 A1
(43) Pub. Date: Nov. 21, 2024

(54) CYLINDRICAL BATTERY

(71) Applicant: Panasonic Energy Co., Ltd., Moriguchi-shi, Osaka (JP)

(72) Inventor: Shuichi Tsunoda, Hyogo (JP)

(73) Assignee: Panasonic Energy Co., Ltd., Moriguchi-shi, Osaka (JP)

(21) Appl. No.: 18/693,742

(22) PCT Filed: Sep. 16, 2022
(86) PCT No.: PCT/JP2022/034754

§ 371 Date: Mar. 20, 2024

(30) Foreign Application Priority Data
Sep. 30, 2021 (JP) 2021-160680

(51) Int. Cl. H01M 50/131; H01M 50/107; H01M 50/119; H01M 50/128

(52) U.S. Cl. CPC H01M 50/131; H01M 50/107; H01M 50/119; H01M 50/128

(57) ABSTRACT

This cylindrical battery comprises: an electrode body in which a long positive electrode and a long negative electrode are wound with a separator therebetween; and a bottomed cylindrical exterior can which accommodates the electrode body. The exterior can includes a cylindrical porous metal section composed of a porous metal. The exterior can may comprise a dense metal section which is disposed inside the porous metal section and is composed of a dense metal.

### TECHNICAL FIELD

The present disclosure generally relates to a cylindrical battery.

### BACKGROUND ART

Among conventional cylindrical batteries, there is a cylindrical battery disclosed in PATENT LITERATURE 1. In this cylindrical battery, an electrode assembly in which an elongated positive electrode and an elongated negative electrode are wound with a separator interposed between the positive electrode and the negative electrode is housed in a bottomed cylindrical exterior housing can. Furthermore, PATENT LITERATURE 2 discloses that since a porous metal is lightweight and has impact absorption performance, it is expected to be used as a material for automobiles, railway vehicles, or the like which may collide with something during the movement.

### CITATION LIST

### Patent Literature

PATENT LITERATURE 1: International Publication No. WO 2019/069890

PATENT LITERATURE 2: Japanese Unexamined Patent Application Publication No. 2006-70286

### SUMMARY

### Technical Problem

An increase in the tension force in the electrode assembly along with an increase in the capacity of the cylindrical battery in recent years has been increasing the risk of an internal short circuit when the cylindrical battery is subjected to impact. In particular, the risk of an internal short circuit occurring starting from a step in the electrode assembly such as a positive electrode lead, an edge of a tape covering the positive electrode lead, and a positive electrode terminal end has been increasing. It is an advantage of the present disclosure to provide a cylindrical battery which can relieve an impact force received by an electrode assembly and can reduce a risk of short circuit.

### Solution to Problem

In order to solve the above-described problems, a cylindrical batter according to the present disclosure comprises an electrode assembly in which an elongated positive electrode and an elongated negative electrode are wound with a separator interposed between the positive electrode and the negative electrode, and a bottomed cylindrical exterior housing can that houses the electrode assembly, wherein the exterior housing can includes a cylindrical porous metal portion formed of a porous metal.

### Advantageous Effects of Invention

In the cylindrical battery according to the present disclosure, an impact force received by an electrode assembly can be relieved and a risk of short circuit can be reduced.

### BRIEF DESCRIPTION OF DRAWING

FIG. 1 is an axial sectional view of a cylindrical battery according to an embodiment of the present disclosure.

FIG. 2 is a perspective view of an electrode assembly of the above-described cylindrical battery.

FIG. 3 is an enlarged schematic view of an R portion illustrated in FIG. 1.

FIG. 4 is an enlarged schematic view in a cylindrical battery of a modified example, corresponding to FIG. 3.

FIG. 5 is an enlarged schematic view in a cylindrical battery of another modified example, corresponding to FIG. 3.

### DESCRIPTION OF EMBODIMENTS

Hereinafter, an embodiment of a cylindrical battery according to the present disclosure will be described in detail with reference to the drawings. The cylindrical battery of the present disclosure may be a primary battery, or may be a secondary battery. Additionally, the cylindrical battery may be a battery using an aqueous electrolyte, or may be a battery using a non-aqueous electrolyte. In the following, a non-aqueous electrolyte secondary battery (lithium ion battery) using a non-aqueous electrolyte will be exemplified as a cylindrical battery 10 of an embodiment, but the cylindrical battery of the present disclosure is not limited to this.

It is assumed from the beginning that a new embodiment is constructed by appropriately combining feature portions of embodiments and modified examples which are described below. In the following embodiments, the same components are denoted by the same reference numerals in the drawings, and duplicate descriptions are omitted. Schematic diagrams are included in a plurality of the drawings, and the dimensional ratios such as lengths, widths and heights of each member between different drawings are not necessarily the same. In this specification, a sealing assembly 17 side in an axial direction (height direction) of a cylindrical battery 10 is defined as “upper”, and a bottom 68 side of an exterior housing can 16 in the axial direction is defined as “lower”. Additionally, of the components described below, components that are not described in the independent claim indicating the highest level concept are arbitrary components, and are not essential components.

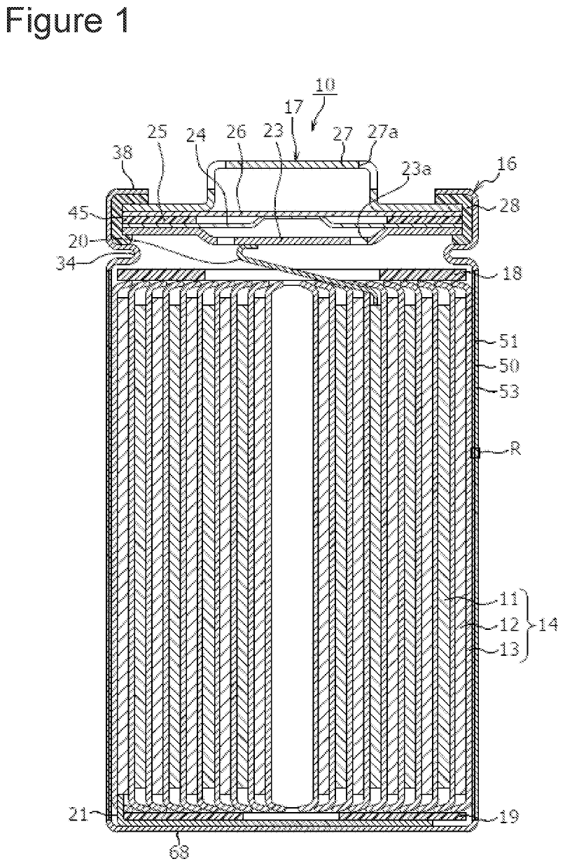

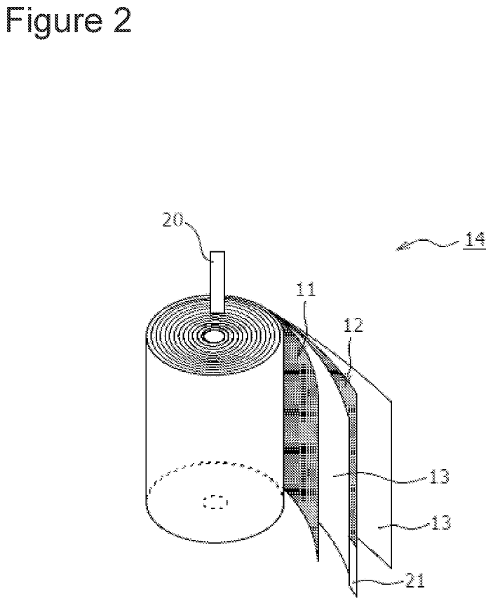

FIG. 1 is an axial sectional view of the cylindrical battery 10 according to an embodiment of the present disclosure, and FIG. 2 is a perspective view of an electrode assembly 14 of the cylindrical battery 10. As illustrated in FIG. 1, the cylindrical battery 10 comprises a wound-type electrode assembly 14, a non-aqueous electrolyte (not illustrated), and a bottomed cylindrical metal exterior housing can 16 that houses the electrode assembly 14 and the non-aqueous electrolyte, and a sealing assembly 17 with which an opening of the exterior housing can 16 is capped. As illustrated in FIG. 2, the electrode assembly 14 has a wound structure in which an elongated positive electrode 11 and an elongated negative electrode 12 are wound with two elongated separators 13 each interposed between the positive electrode 11 and the negative electrode 12.

The negative electrode 12 is formed to be one size larger than the positive electrode 11 in order to prevent precipitation of lithium. That is, the negative electrode 12 is formed to be longer in the longitudinal direction and the width direction (short direction) than the positive electrode 11. The two separators 13 are each formed to be at least one size larger than the positive electrode 11, and are disposed so as to interpose, for example, the positive electrode 11 therebetween. The negative electrode 12 may include a winding start end of the electrode assembly 14. However, the separator 13 generally extends beyond a winding start side end of the negative electrode 12, and a winding start side end of the separator 13 serves as the winding start end of the electrode assembly 14.

The non-aqueous electrolyte includes a non-aqueous solvent, and an electrolyte salt dissolved in the non-aqueous solvent. Examples of the non-aqueous solvent may include esters, ethers, nitriles, amides, and mixed solvents containing two or more selected from the foregoing. The non-aqueous solvent may contain a halogen-substituted product obtained by substituting at least some of hydrogen atoms in these solvents with a halogen atom such as fluorine. Note that the non-aqueous electrolyte is not limited to a liquid electrolyte and may be a solid electrolyte that uses a gel polymer or the like. As the electrolyte salt, a lithium salt such as LiPF₆ is used.

The positive electrode 11 has a positive electrode current collector and a positive electrode mixture layer formed on each surface of the positive electrode current collector. Examples of the positive electrode current collector may include a foil of metal such as aluminum or an aluminum alloy, which is stable within a potential range of the positive electrode 11, and a film in which such a metal is disposed on a surface layer thereof. The positive electrode mixture layer includes a positive electrode active material, a conductive agent, and a binder. The positive electrode 11 can be produced by, for example, applying a positive electrode mixture slurry including a positive electrode active material, a conductive agent, a binder, and the like on a positive electrode current collector, drying the resulting coating film, and then compressing the coating film to form a positive electrode mixture layer on each surface of the current collector.

The positive electrode active material is composed of a lithium-containing metal composite oxide as a main component. Examples of metal elements contained in the lithium-containing metal composite oxide include Ni, Co, Mn, Al, B, Mg, Ti, V, Cr, Fe, Cu, Zn, Ga, Sr, Zr, Nb, In, Sn, Ta, and W. An example of a preferable lithium-containing metal composite oxide is a composite oxide containing at least one of Ni, Co, Mn and Al.

Examples of the conductive agent included in the positive electrode mixture layer may include carbon materials such as carbon black, acetylene black, Ketjen black, and graphite. Examples of the binder included in the positive electrode mixture layer may include fluorocarbon resins such as polytetrafluoroethylene (PTFE) and polyvinylidene fluoride (PVdF), polyacrylonitrile (PAN), polyimide resins, acrylic resins, and polyolefin resins. These resins may be used in combination with cellulose derivatives such as carboxymethyl cellulose (CMC) or a salt thereof, a polyethylene oxide (PEO), or the like.

The negative electrode 12 has a negative electrode current collector and a negative electrode mixture layer formed on each surface of the negative electrode current collector. Examples of the negative electrode current collector may include a foil of a metal such as copper or a copper alloy, which is stable within a potential range of the negative electrode 12, and a film in which such a metal is disposed on a surface layer thereof. The negative electrode mixture layer includes a negative electrode active material, and a binder. The negative electrode 12 can be produced by, for example, applying a negative electrode mixture slurry including a negative electrode active material, a binder, and the like on a negative electrode current collector, drying the resulting coating film, and then compressing the coating film to form a negative electrode mixture layer on each surface of the current collector.

As the negative electrode active material, a carbon material that reversibly occludes and releases lithium ions is generally used. A preferable carbon material is graphite including natural graphite such as flaky graphite, massive graphite, and earthy graphite, and artificial graphite such as massive artificial graphite and graphitized mesophase carbon microbeads. As the negative electrode active material, a silicon (Si) material containing Si may be included in the negative electrode mixture layer. As the negative electrode active material, a metal alloyed with lithium other than Si, an alloy containing such a metal, a compound containing such a metal, and the like may be used.

As the binder included in the negative electrode mixture layer, fluorocarbon resins, PAN, polyimide resins, acrylic resins, polyolefin resins, and the like may be used as in the case of the positive electrode 11, and a styrene-butadiene rubber (SBR) or a modification thereof is preferably used. In the negative electrode mixture layer, for example, in addition to SBR and the like, CMC or a salt thereof, polyacrylic acid (PAA) or a salt thereof, polyvinyl alcohol, or the like may be included.

A porous sheet having ion permeability and an insulation property is used as the separator 13. Specific examples of the porous sheet include a microporous thin film, a woven fabric, and a nonwoven fabric. The material of the separator 13 is preferably a polyolefin resin such as polyethylene or polypropylene, or a cellulose. The separator 13 may be either a single layer structure or a laminated structure. A heat-resistant layer or the like may be formed on a surface of the separator 13.

As illustrated in FIG. 1, a positive electrode lead 20 is bonded to the positive electrode 11, and a negative electrode lead 21 is bonded on a winding finish side end in the longitudinal direction of the negative electrode 12. The cylindrical battery 10 has an insulating plate 18 above the electrode assembly 14, and has an insulating plate 19 below the electrode assembly 14. The positive electrode lead 20 extends toward the sealing assembly 17 through a through hole of the insulating plate 18, and the negative electrode lead 21 extends toward a bottom 68 of the exterior housing can 16 through the outside of the insulating plate 19. The positive electrode lead 20 is connected to a lower surface of a bottom plate 23 of the sealing assembly 17, by means of welding or the like. A terminal cap 27 constituting a top plate of the sealing assembly 17 is electrically connected to the bottom plate 23, and serves as a positive electrode terminal. The negative electrode lead 21 is connected to an inner surface of the bottom 68 of the metal exterior housing can 16 by means of welding or the like, and the exterior housing can 16 serves as a negative electrode terminal.

In the example illustrated in FIGS. 1 and 2, the positive electrode lead 20 is electrically connected to an intermediate portion such as a center portion in the winding direction of the positive electrode current collector, and the negative electrode lead 21 is electrically connected to a winding finish side end in the winding direction of the negative electrode current collector. However, the negative electrode lead may be electrically connected to a winding start side end in the winding direction of the negative electrode current collector. Alternatively, the electrode assembly may have two negative electrode leads in which one of the negative electrode leads is electrically connected to the winding start side end in the winding direction of the negative electrode current collector, and the other negative electrode lead is electrically connected to the winding finish side end in the winding direction of the negative electrode current collector. Alternatively, the winding finish side end in the winding direction of the negative electrode current collector may be brought into contact with an inner surface of the exterior housing can so that the negative electrode and the exterior housing can are electrically connected to each other.

The cylindrical battery 10 further comprises a resin gasket 28 disposed between the exterior housing can 16 and the sealing assembly 17. The sealing assembly 17 is fixed by caulking to an opening of the exterior housing can 16 with the gasket 28 interposed therebetween. In this way, an internal space of the cylindrical battery 10 is closed. The gasket 28 is held between the exterior housing can 16 and the sealing assembly 17, and insulates the sealing assembly 17 from the exterior housing can 16. The gasket 28 has a role of a seal material for maintaining the airtightness of the inside of the battery, and a role as an insulating material for insulating the sealing assembly 17 from the exterior housing can 16.

The exterior housing can 16 houses the electrode assembly 14 and the non-aqueous electrolyte, and has a shoulder 38, a grooved portion 34, a cylindrical portion 50, and a bottom 68. The grooved portion 34 can be formed by, for example, annularly recessing the one part of the side wall of the exterior housing can 16 toward the radially inward side by a radially inward spinning process. The shoulder 38 is formed by bending an upper end of the exterior housing can 16 to the inner side toward a circumferential edge 45 of the sealing assembly 17 when the sealing assembly 17 is fixed by caulking to the exterior housing can 16.

The sealing assembly 17 has a stacked structure of the bottom plate 23, a lower vent member 24, an insulating member 25, an upper vent member 26, and the terminal cap 27 in this order from the electrode assembly 14 side. Each member constituting the sealing assembly 17 has, for example, a disk shape or a ring shape, and each member except for the insulating member 25 is electrically connected to each other. The bottom plate 23 has at least one through hole 23a. The lower vent member 24 and the upper vent member 26 are connected to each other at respective centers thereof, and the insulating member 25 is interposed between the circumferential edges of the vent members 24 and 26.

If abnormal heat generation occurs in the cylindrical battery 10 and the internal pressure of the cylindrical battery 10 increases, the lower vent member 24 is deformed so as to push the upper vent member 26 upward to the terminal cap 27 side to break, resulting in cutting off of a current path between the lower vent member 24 and the upper vent member 26. If the internal pressure further increases, the upper vent member 26 breaks, and gas is discharged from a through hole 27a in the terminal cap 27. This gas discharge can prevent the cylindrical battery 10 from rupturing due to an excessive increase in internal pressure of the cylindrical battery 10, which makes it possible to improve the safety of the cylindrical battery 10.

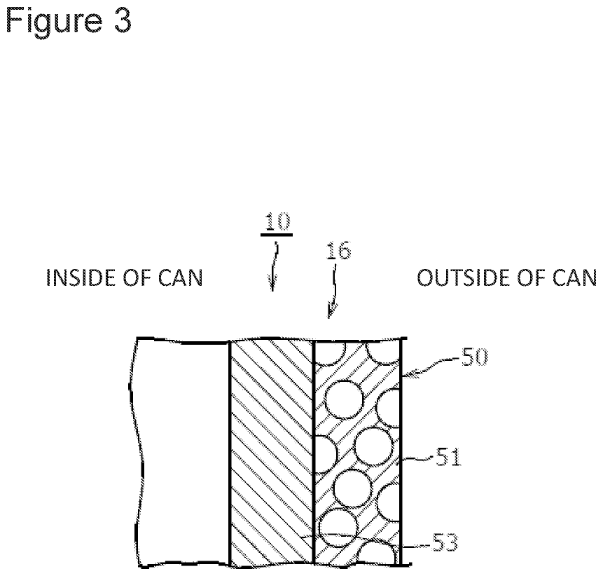

FIG. 3 is an enlarged schematic view of an R portion illustrated in FIG. 1. As illustrated in FIGS. 1 and 3, the exterior housing can 16 comprises a cylindrical porous metal portion 51 formed of a porous metal, and a dense metal portion 53 disposed radially inside of the porous metal portion 51. The dense metal portion 53 is formed of a dense metal having low porosity. The porous metal portion 51 and the dense metal portion 53 are disposed in the cylindrical portion 50 located between the grooved portion 34 and the bottom 68 in the exterior housing can 16. In the embodiment illustrated in FIG. 1, the cylindrical portion 50 of the exterior housing can 16 includes a two-layer structure composed of the porous metal portion 51 and the dense metal portion 53. The porous metal portion 51 need not be disposed in the entire range of the cylindrical portion 50 of the exterior housing can 16, but, for example, the porous metal portion 51 is preferably disposed in a range, which faces a side wall of the electrode assembly 14, in the cylindrical portion 50. Note that, a portion of the exterior housing can 16 except for the porous metal portion 51 and the dense metal portion 53 is preferably formed of a dense metal, similarly to the dense metal portion 53.

The porosity of the dense metal portion 53 is preferably less than or equal to 1%. On the other hand, the porosity of the porous metal portion 51 is preferably greater than or equal to 10%, more preferably greater than or equal to 40%, still more preferably greater than or equal to 70%. The porosity of the porous metal portion 51 is, for example, less than or equal to 95%, and is preferably less than or equal to 90% in view of the mechanical strength.

The exterior housing can 16 is produced as follows, for example. Specifically, a low-carbon steel sheet is formed into a cylindrical can. At this time, in the cylindrical can, the thickness of a portion facing the side wall of the electrode assembly 14 is made smaller than the thickness of the other portion to thereby form a thin thickness portion in a cylindrical portion. Then, the formed cylindrical can is placed in the center of a cylindrical mold having an inner diameter larger than the outer diameter of the cylindrical can, and a slurry in which low-carbon steel powder, resin balls, and a resin binder as a binder are mixed is poured into between the thin thickness portion in the cylindrical portion of the cylindrical can and the mold, and then is subjected to a sintering process. Then, the cylindrical can is released from the cylindrical mold. In this way, the exterior housing can 16 in which the porous metal portion is formed around the thin thickness portion is produced. Note that the porous metal portion can be produced in a wide variety of production methods. The porous metal portion may be produced using any of the wide variety of production methods.

### Effects of Cylindrical Battery 10

In the cylindrical battery 10, a porous metal having, for example, the porosity of greater than or equal to 70% and less than or equal to 90% and impact absorption performance is used as the material of the porous metal portion 51 of the exterior housing can 16. Accordingly, the impact energy can be absorbed by the porous metal portion 51 of the exterior housing can 16 upon impact, and a collapsed amount of the exterior housing can 16 can be reduced. Therefore, the impact received by the electrode assembly 14 can be reduced, and a risk of internal short circuit can be reduced.

Furthermore, the dense metal portion 53 formed of a dense metal having the porosity of less than or equal to 1% is disposed inside the porous metal portion 51. Accordingly, the electrolyte such as an electrolytic solution filled in the exterior housing can 16 can be substantially prevented from permeating the exterior housing can 16 (pours), and the electrode assembly 14 can be filled with a sufficient amount of electrolyte.

### Example 1

### [Production of Exterior Housing Can]

A low-carbon steel plate was formed into a cylindrical can having an outer diameter of 18.0 mm, a side thickness of 0.2 mm, a bottom thickness of 0.4 mm, and a height of 80.0 mm. At this time, a thin thickness portion (having a thickness of 0.125 mm) having a small outer diameter was provided in a portion, which faced the electrode assembly 14, in the cylindrical portion of the cylindrical can. Then, the formed cylindrical can was placed in the center of a cylindrical mold, and a slurry in which low-carbon steel powder having a diameter of 0.01 mm, resin balls having a diameter of 0.01 mm, and a resin binder as a binder were mixed was poured into between the thin thickness portion of the cylindrical can and the mold, and then is subjected to a sintering process, and thus the porous metal portion was formed outside the thin thickness portion so that the outer diameter was 18.0 mm. Then, the cylindrical can was released from the mold to produce the exterior housing can having an outer diameter of 18 mm, a side thickness of 0.25 mm, a bottom thickness of 0.4 mm, and a height of 69.1 mm. In this way, two layers of the porous metal portion 51 and the dense metal portion 53 were provided in a portion, which faced a side wall of the electrode assembly 14, in the exterior housing can, the porous metal portion 51 being formed of a porous metal having a pore size of 0.01 mm and porosity of 70%, the dense metal portion 53 being formed of a dense metal. Note that, a portion of the exterior housing can 16 except for the porous metal portion 51 and the dense metal portion 53 was formed of a dense metal, similarly to the dense metal portion 53.

### [Production of Positive Electrode]

An aluminum-containing lithium nickel cobalt oxide (LiNi_{0.91}Co_{0.04}Al_{0.05}O₂) was used as a positive electrode active material. Subsequently, 98.6 parts by mass of LiNi_{0.91}Co_{0.04}Al_{0.05}O₂ (positive electrode active material), 0.8 parts by mass of acetylene black, and 0.6 parts by mass of polyvinylidene fluoride (PVDF) (binder) were mixed in a solvent of N-methyl-pyrrolidone (NMP) to obtain a positive electrode slurry. The positive electrode slurry was uniformly applied on each surface of an aluminum foil having a thickness of 15 μm. Next, in a heated dryer, after the heat treatment was performed at a temperature of 100 to 150° C. to remove NMP, rolling was performed using a roll press machine. Furthermore, after the rolling was performed, a positive electrode was brought into contact with a roll heated to 200° C. for 5 seconds to perform the heat treatment, and was cut to a size of a thickness of 0.178 mm, a width of 58.4 mm, and a length of 553 mm to produce a positive electrode.

### [Production of Negative Electrode]

As a negative electrode active material, mixing of 86.5 parts by mass of graphite powder, and 13.5 parts by mass of Si oxide was performed. Subsequently, 1 part by mass of CMC as a thickening agent, and 1 part by mass of a dispersion of acrylonitrile-butadiene rubber as a binder were dispersed in water to prepare a negative electrode slurry. The negative electrode slurry was applied on each surface of a negative electrode current collector made with a copper foil having a thickness of 10 μm to form a negative electrode applied portion. Next, after drying, the thickness of the negative electrode mixture layer was adjusted by compression using compression rollers so that the thickness of a negative electrode was 0.170 mm, and the negative electrode was cut to a size of a width of 59.5 mm and a length of 622 mm to produce a negative electrode.

### [Preparation of Non-Aqueous Electrolytic Solution]

LiPF₆ of 1.3 mol/L was dissolved in a mixed solvent (volume ratio; EC:EMC:DMC=20:5:75) containing ethylene carbonate (EC), ethyl methyl carbonate (EMC), and dimethyl carbonate (DMC), thereby preparing a non-aqueous electrolytic solution.

### [Production of Cylindrical Battery]

The positive electrode lead made of aluminum was attached to the positive electrode current collector, and the negative electrode lead made of nickel-copper-nickel was attached to the negative electrode current collector. Subsequently, the positive electrode, the negative electrode, and the separator were wound in a state where a separator made of polyethylene was disposed between the positive electrode current collector and the negative electrode current collector, and a tape was applied to the outermost circumference of a wound assembly including a winding finish end of the negative electrode, to produce a wound-type electrode assembly. At this time, a negative electrode current collector exposed portion was disposed on the outermost circumferential portion of the electrode assembly.

Next, insulating plates were disposed above and below the electrode group, were inserted into the above-described produced exterior housing can, and the negative electrode lead was welded to the exterior housing can, the positive electrode lead was welded to a sealing plate having an inner pressure sensitive safety vent, and they were housed in the exterior housing can. Then, the non-aqueous electrolyte solution was injected into the battery case by a pressurization method. Finally, an opening end of the battery case was caulked to the sealing assembly via the gasket to produce a cylindrical battery (non-aqueous electrolyte secondary battery). The capacity of the battery was 3685 mAh.

### Example 2

Compared to Example 1, a cylindrical battery was produced in the same production method as Example 1 except that a porous metal slurry to be poured into a cylindrical mold was changed and the porosity of the porous metal portion of the exterior housing can was set to 40%.

### Comparative Example

Compared to Example 1, a cylindrical battery was produced in the same production method as Example 1 except that the exterior housing can is formed of only a dense metal.

### (Collision Test)

The following collision test was performed on the cylindrical batteries of Examples 1 and 2, and Comparative Example. Specifically, the test was performed in which each battery was charged at SOC of 50%, and a weight of 9.1 kg was dropped from a height of 700 mm in the state where a round bar of 15.8 mm contacted the battery side wall. The test was performed at circumferential positions 0°, 45°, 90°, 135° and 180° of the positive electrode lead with respect to a center axis of the battery. Note that in the state where the round bar contacted the battery side wall, the circumferential position of the positive electrode lead when a center of the positive electrode lead was located on a line connecting a contact between the battery and the round bar and the center axis of the battery was regarded as 0°. The collision test was performed once for each of the above five positions in each battery. Then, it was investigated whether short circuit occurs in each battery.

### (Test Results)

TABLE 1

| Circumferential | | | |
|---|---|---|---|
| position of positive | | | Comparative |
| electrode lead | Example 1 | Example 1 | Example |
| 0° | No short circuit | No short circuit | No short circuit |
| | occurred | occurred | occurred |
| 45° | No short circuit | Short circuit | Ignition occurred |
| | occurred | occurred | |
| 90° | No short circuit | No short circuit | No short circuit |
| | occurred | occurred | occurred |
| 135° | No short circuit | No short circuit | Short circuit |
| | occurred | occurred | occurred |
| 180° | No short circuit | No short circuit | No short circuit |
| | occurred | occurred | occurred |

The test results are shown in Table 1. As shown in Table 1, regarding 45° and 125° at which breakage of the separator is likely to occur, in the battery of Comparative Example, the ignition occurred at 45° and the short circuit occurred at 135°. In contrast, in Example 2 in which the porosity of the porous metal portion was 40%, the short circuit occurred at 45° and the short circuit did not occur at 135°. In Example 1 in which the porosity of the porous metal portion was 70%, the short circuit did not occur at all angles.

Accordingly, when the cylindrical porous metal portion 51 formed of a porous metal is provided in the cylindrical portion 50 of the exterior housing can 16 which faces the side wall of the electrode assembly 14, the collision energy absorbed by the exterior housing can 16 can be increased and the impact force received by the electrode assembly 14 can be reduced. The porosity of the porous metal portion 51 is preferably greater than or equal to 40% and less than or equal to 95%, more preferably greater than or equal to 70% and less than or equal to 90%. Furthermore, when the dense metal portion 53 formed of a dense metal is provided inside the porous metal portion 51, the impact energy at the collision of the exterior housing can 16 can be significantly increased and a risk of the internal short circuit in the electrode assembly 14 can be greatly reduced.

### Modification Example

The present disclosure is not limited to the above embodiment and modified examples thereof, and various improvements and changes are possible within the matters described in the claims of the present application and the scope of equivalence of claims. For example, in the above embodiments, the dense metal portion 53 is disposed inside the exterior housing can 16, and the porous metal portion 51 is disposed outside the exterior housing can 16. However, the porous metal portion may be disposed inside the exterior housing can 16, and the dense metal portion may be disposed outside the exterior housing can 16.

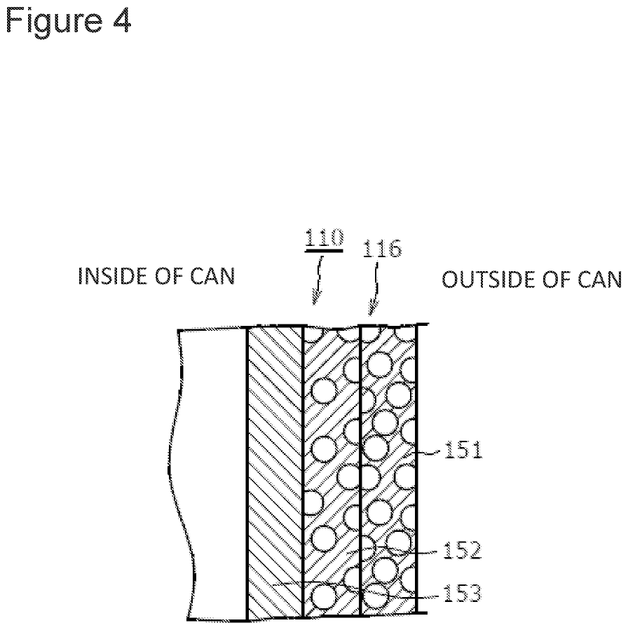

As illustrated in FIG. 4 or an enlarged schematic sectional view in a cylindrical battery 110 of a modified example, corresponding to FIG. 3, a cylindrical portion of an exterior housing can 116 may have a three-layer structure. A porous metal portion 151 formed of a first porous metal having first porosity may be disposed in the outermost layer outside the can, a second porous portion 152 formed of a second porous metal having second porosity lower than the first porosity may be disposed in a center layer provided radially inside the first porous metal portion 151, and a dense metal portion 153 formed of a dense metal may be disposed in the innermost layer inside the can. In this way, the cylindrical portion of the exterior housing can may have a plurality of layers so that the porosity is gradually reduced from the outside of the can toward the inside of the can. In this case, the innermost layer inside the can may be formed of a porous metal or a dense metal.

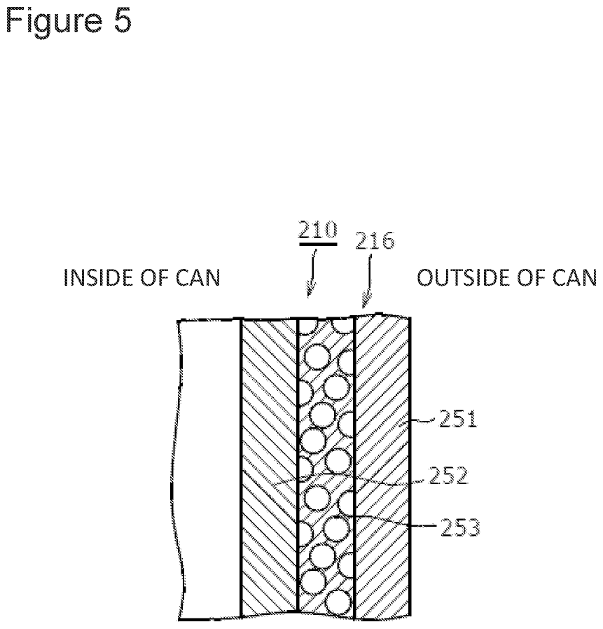

As illustrated in FIG. 5 or an enlarged schematic sectional view in a cylindrical battery 210 of another modified example, corresponding to FIG. 3, a cylindrical portion of an exterior housing can 216 may have a three-layer structure in which dense metal portions 251 and 252 formed of a dense metal are disposed in the outermost layer outside the can and the innermost layer inside the can, respectively, and a porous metal portion 253 formed of a porous metal is disposed in an intermediate layer between the outermost layer and the innermost layer. This can not only reduce the impact force received by the electrode assembly 14 but also prevent the electrolyte from permeating the exterior housing can 216. Furthermore, this can provide high corrosion resistance of a portion of the exterior housing can 216 exposed to the outside. As described above, in the cylindrical battery of the present disclosure, it is only required that the exterior housing can includes a cylindrical porous metal portion formed of a porous metal. According to the cylindrical battery of the present disclosure, providing the porous portion makes it possible to relieve an impact force and reduce a risk of short circuit.

### REFERENCE SIGNS LIST

10, 110, 210 Cylindrical battery, 11 Positive electrode, 12 Negative electrode, 13 Separator, 14 Electrode assembly, 16, 116, 216 Exterior housing can, 17 Sealing assembly, 18, 19 Insulating plate, 20 Positive electrode lead, 21 Negative electrode lead, 23 Bottom plate, 23a Through hole, 24 Lower vent member, 25 Insulating member, 26 Upper vent member, 27 Terminal cap, 27a Through hole, 28 Gasket, 34 Grooved portion, 38 Shoulder, 45 Circumferential edge, 50 Cylindrical portion, 51, 253 Porous metal portion, 53, 153, 251, 252 Dense metal portion, 68 Bottom, 151 First porous metal portion, 152 Second porous metal portion

1. A cylindrical battery, comprising:
an electrode assembly in which an elongated positive electrode and an elongated negative electrode are wound with a separator interposed between the positive electrode and the negative electrode; and
a bottomed cylindrical exterior housing can that houses the electrode assembly,
wherein the exterior housing can includes a cylindrical porous metal portion formed of a porous metal.

2. The cylindrical battery according to claim 1, wherein
the exterior housing can comprises a dense metal portion formed of a dense metal, the dense metal portion being disposed inside the porous metal portion.

3. The cylindrical battery according to claim 1, wherein
the porous metal portion has porosity of greater than or equal to 70% and less than or equal to 90%.
